(19) United States
(12) Patent Application Publication
(10) Pub. No.: US 2012/0057894 A1
(43) Pub. Date: Mar. 8, 2012

(54) DEVICE AND METHOD FOR LIMITING AMPERAGE DRAW OF PRINTING DEVICE

(75) Inventors: Tab A. Tress, Henrietta, NY (US); Robert Pawlik, Canandaigua, MD (US); Brian James Gillis, Penfield, NY (US)

(73) Assignee: XEROX CORPORATION, NORWALK, CT (US)

(21) Appl. No.: 12/877,139

(22) Filed: Sep. 8, 2010

(51) Int. Cl. G03G 15/00

(52) U.S. Cl. 399/88

(57) ABSTRACT

A method and printing apparatus include a plurality of components and a controller operatively connected to the components. Further, a power supply is also operatively connected to the components. The controller selectively limits the operations of selected ones of the components to prevent all the components of the printing apparatus from collectively drawing from the power supply an amount of power that exceeds a power limit.

### BACKGROUND

Embodiments herein generally relate to printing devices and more particularly to a device and method that limits the maximum amperage that will be drawn from an alternating current power socket.

As the abilities of modern printing devices evolve, their power requirements increase. For example, traditional monochrome (black and white) printing devices sometimes had only a single printing engine; however, modern multi-color printing devices can have five, seven, or even a greater number of printing engines. Further, additional accessories such as multiple selectable sheet feeder trays, duplexing components, and finisher components (staplers, sorter, etc.) each increase the power draw of the printing device. While some advances have been made in reducing the power consumption of individual devices, many advanced printing devices have difficulty operating on limited amperages that are supplied throughout the world.

For example, in North America and Japan, offices and homes are commonly supplied with power sockets (receptacles, outlets, etc.) that operate at a voltage between 100-120, 60 Hz, with a 15 amp limit. Many Eastern and Western European and Asian buildings are wired to operate at a voltage between 200-250, at 50 Hz, with an amperage limit between 13 and 17. However, because of the additional features offered by advanced printing devices, they can often draw 20 amps or more. The embodiments described below address this situation and provide the ability of modern complex printing devices to work within lower amperage draw limits, without sacrificing functionality.

### SUMMARY

According to one embodiment herein, a printing apparatus includes a plurality of components and a controller operatively connected to (directly or indirectly connected to) the components. Further, a power supply is also operatively connected to the components. The controller selectively limits the operations of selected ones of the components to prevent all the components of the printing apparatus from collectively drawing from the power supply an amount of power that exceeds a power limit.

The limits imposed by the controller prioritize power allocation among the components. More specifically, the limits assign different ones of the components different power priorities at different times (during different operational cycles) of the printing apparatus. Such limits delay operations of relatively lower priority components and allow operations of relatively higher priority components when a collective draw from both the lower priority components and the higher priority components would exceed the power limit. For example, the controller can limit the printing apparatus from drawing more than 13-17 amps from an alternating current power socket.

Another embodiment is a printing apparatus that comprises a main power supply operatively connected to the controller and to all power consuming components within the printing apparatus. The controller selectively limits operations of ones of the components to space the timing of different activities of the components to prevent all the components of the printing apparatus from collectively drawing from the power supply an amount of power that exceeds a predetermined amperage limit.

A method embodiment herein controls a printing apparatus by using a controller that is operatively connected to a plurality of components to control a power supply that is also operatively connected to the components. This method uses the controller to selectively limit operations of ones of the components to prevent all the components from collectively drawing from the power supply an amount of power that exceeds a power limit.

Another method herein controls a printing apparatus by using a controller that is operatively connected to all power consuming components within the printing apparatus to control a power supply that is also operatively connected to all the components. The method uses the controller to selectively limit operations of ones of the components to space the timing of different activities of the components to prevent all the components from collectively drawing from the power supply an amount of power that exceeds a predetermined amperage limit.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a side-view schematic diagram of a device according to embodiments herein; and

FIG. 2 is a flowchart illustrating method embodiments herein.

### DETAILED DESCRIPTION

As mentioned above, because of the additional features offered by advanced printing devices, such devices can often draw 20 amps or more from the power outlet socket, which may exceed the wiring amperage limit of many homes and offices where the printing devices are utilized. In view of such issues, embodiments described below address this situation and provide the ability of modern complex printing devices to work within lower amperage draw limits, without sacrificing functionality.

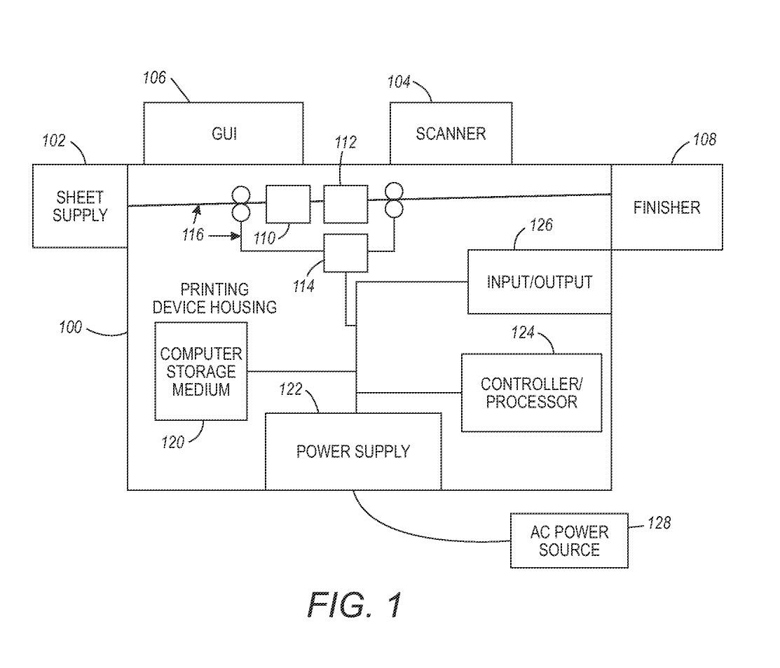

The embodiments herein provide a printing apparatus, such as the printing apparatus 100 shown in FIG. 1. As shown, the printing apparatus 100 includes a plurality of components (102, 104, 106, 108, 110, 112, 114, 116, 126, etc.) and a controller/processor 124 operatively connected to (directly or indirectly connected to) the components. Further, a power supply 122 is also operatively connected to the components.

As would be understood by those ordinarily skilled in the art, the printing device 100 shown in FIG. 1 is only one example, and the embodiments herein are equally applicable to other types of printing devices that may include less components or more components. For example, while a limited number of printing engines and paper paths are illustrated in FIG. 1, those ordinarily skilled in the art understand that many more paper paths and additional printing engines could be included within any printing device used with embodiments herein. The various devices illustrated in FIG. 1 can operate on relatively low voltages (5 V) or relatively higher voltages, (12 V, 24 V, etc.)

Specifically, FIG. 1 illustrates a printer body housing 100 having one or more functional components such as printing engines (marking devices) 110, 112, 114 that operate on power supplied from the alternating current (AC) 128 by the power supply 122. The printing engines 110, 112, 114 can include, for example, drive modules, heaters, fusers, lamps, etc. The power supply 122 connects to the external alternating current power source 128 and converts the external power into the type of power needed by the various components shown in FIG. 1. The power supply 122 includes a line current monitoring device and can comprise a low voltage power supply or a high voltage power supply.

Further, the printing device 100 includes at least one accessory functional component (such as a scanner/document handler 104, sheet supply 102, finisher 108, etc.) and graphic user interface assembly 106 that also operate on the power supplied from the external power source 128 (through the power supply 122).

In the multi-function printing device shown in FIG. 1, sheets of media are supplied from a sheet supply 102 along a paper path 116 (which may include a duplex loop) to the various printing engines 110, 112, 114. After receiving various markings from the printing engines 110, 112, 114, the sheets of media pass to a finisher 108 which can fold, staple, sort, etc., the various printed sheets.

An input/output device 126 is used for communications to and from the multi-function printing device 100. The processor 124 controls the various actions of the printing device. A non-transitory computer storage medium 120 (which can be optical, magnetic, capacitor based, etc.) is readable by the processor 124 and stores instructions that the processor 124 executes to allow the multi-function printing device to perform its various functions, such as those described above.

In order to insure that the power supply 122 does not draw more than a predetermined amperage from the AC power source 128, the controller 124 selectively limits the operations of selected ones of the components to prevent all the components of the printing apparatus from collectively and simultaneously drawing from the power supply 122 an amount of power that exceeds the predetermined power limit.

Thus, the limits imposed by the controller 124 prioritize power allocation among the components. More specifically, the limits assign different ones of the components different power priorities at different times during different operational cycles of the printing apparatus. Such limits delay operations of relatively lower priority components and allow operations of relatively higher priority components when a simultaneous collective draw from both the lower priority components and the higher priority components would exceed the power limit. For example, the controller 124 can limit the printing apparatus from drawing more than 13-17 amps from an alternating current power socket.

Stated differently, the printing apparatus 100 has a main power supply 122 operatively connected to the controller 124 and to all power consuming components (102, 104, 106, 108, 110, 112, 114, 116, 126, etc.) within the printing apparatus 100. The controller 124 selectively limits operations of certain ones of the components to space the timing of different activities of the components to prevent all the components of the printing apparatus from collectively drawing from the power supply 122 an amount of power that exceeds a predetermined amperage limit. Further, when altering normal operations in order to maintain the printing device within the predetermined power (amperage) limit, messages can be provided to the user through the graphic user interface 106 so that the user does not become concerned if the printing device is not behaving in a manner in which they expect.

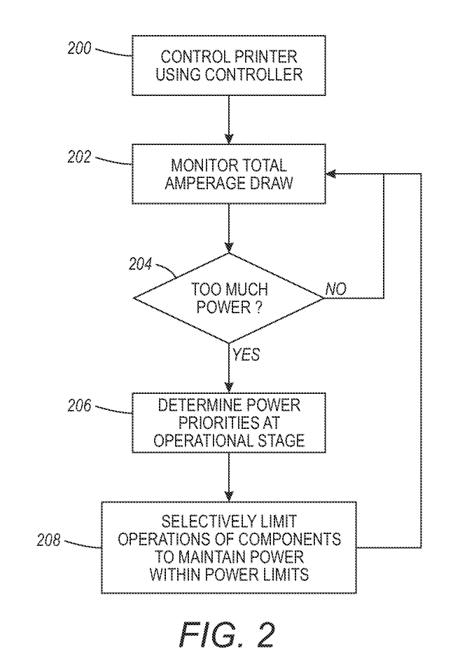

FIG. 2 is a flow diagram that illustrates various method embodiments herein. In item 200, one exemplary method embodiment herein controls a printing apparatus by using a controller that is operatively connected to a plurality of components. The controller also controls the power supply that is also operatively connected to the components.

The method herein monitors the total amperage being drawn by a printing device using the current monitor within the power supply as shown in item 202. Item 204 determines whether too much power is being drawn from the alternating current power outlet socket. The power limit in item 204 can be set to be equal to the maximum desired amperage (e.g., 15 amps) or can be set to some percentage of the maximum desired amperage (75%, 80%, 90%, etc.). If the amperage limit is not exceeded in item 204, processing returns to item 202 to continue monitoring the total amperage draw.

To the contrary, if too much power is being drawn, processing proceeds to item 206, where the embodiments herein determine the power priorities at the current operational stage in which the printer is operating. As mentioned above, the limits applied by the processor assign different ones of the components different power priorities at different times during different operational cycles of the printing apparatus.

For example, if one print job has just completed the marking operations and another print job is beginning marking operations, marking operations on the second print job may be delayed while various finisher operations (stapling, sorting, etc.) are performed so that the combination of the finishing operations and the marking operations do not cause the printing device to exceed the amperage limit. Therefore, in item 206, the embodiments herein give the finishing operations of the first print job higher priority than the marking operations of the second print job. Similarly, sheet movement operations may be delayed, while higher priority marking operations are performed; components that are normally warmed up simultaneously, can be warmed up sequentially (in the priority order in which they will be used); the timing of fusing operations can be separated from the timing of marking operations; the operations of the scanner/document handler can be separated from other components; etc., in item 206.

Then after determining which printing components have the higher power priorities in item 206, the method uses the controller to selectively delay operations of ones of the components to prevent all the components from collectively drawing from the power supply an amount of power that exceeds the power limit in item 208.

With embodiments herein, such limits merely delay operations (and do not cancel operations) of relatively lower priority components, while allowing the operations of relatively higher priority components to continue. Therefore, no functionality of the printing device is lost. Further, if the process of delaying various operations within the printing device causes the printing device to operate in a slower than normal manner, this slower operation will not be a constant characteristic of the printing device, but instead will only occur when the slowdown is necessary in order to maintain the predetermined amperage limits. Thus, the embodiments herein allow the printing device to operate in a substantially normal manner yet allow the printing device to be used with more commonly available power outlet sockets with lower amperage ratings.

Thus, the methods herein control the printing apparatus by using a controller that is operatively connected to all power consuming components within the printing apparatus to control the power supply (that is also operatively connected to all the components). The method uses the controller to selectively limit operations of certain ones of the components to space the timing of different activities of the components to prevent all the components from collectively drawing from the power supply an amount of power that exceeds a predetermined amperage limit.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A printing apparatus comprising:
a plurality of components;
a controller operatively connected to said components; and
a power supply operatively connected to said components,
said controller selectively limiting operations of ones of said components to prevent all said components of said printing apparatus from collectively drawing from said power supply an amount of power that exceeds a power limit.

2. The printing apparatus according to claim 1, said limiting comprising prioritizing power allocation among said components.

3. The printing apparatus according to claim 1, said limiting comprising assigning different ones of said components different power priorities at different times during different operational cycles of said printing apparatus.

4. The printing apparatus according to claim 1, said limiting comprising delaying operations of relatively lower priority components and allowing operations of relatively higher priority components when a collective draw from both said lower priority components and said higher priority components would exceed said power limit.

5. The printing apparatus according to claim 1, said controller limiting said printing apparatus from drawing more than 13-17 amps from an alternating current power socket.

6. A printing apparatus comprising:
a controller; and
a main power supply operatively connected to said controller and to all power consuming components within said printing apparatus,
said controller selectively limiting operations of ones of said components to space the timing of different activities of said components to prevent all said components of said printing apparatus from collectively drawing from said power supply an amount of power that exceeds a predetermined amperage limit.

7. The printing apparatus according to claim 6, said limiting comprising prioritizing power allocation among said components.

8. The printing apparatus according to claim 6, said limiting comprising assigning different ones of said components different power priorities at different times during different operational cycles of said printing apparatus.

9. The printing apparatus according to claim 6, said limiting comprising delaying operations of relatively lower priority components and allowing operations of relatively higher priority components when a collective draw from both said lower priority components and said higher priority components would exceed said amperage limit.

10. The printing apparatus according to claim 6, said controller limiting said printing apparatus from drawing more than 13-17 amps from an alternating current power socket.

11. A method to control a printing apparatus comprising:
using a controller that is operatively connected to a plurality of components to control a power supply that is also operatively connected to said components; and
using said controller, selectively limiting operations of ones of said components to prevent all said components from collectively drawing from said power supply an amount of power that exceeds a power limit.

12. The method to control said printing apparatus according to claim 11, said limiting comprising prioritizing power allocation among said components.

13. The method to control said printing apparatus according to claim 11, said limiting comprising assigning different ones of said components different power priorities at different times during different operational cycles of said printing apparatus.

14. The method to control said printing apparatus according to claim 11, said limiting comprising delaying operations of relatively lower priority components and allowing operations of relatively higher priority components when a collective draw from both said lower priority components and said higher priority components would exceed said power limit.

15. The method to control said printing apparatus according to claim 11, said controller limiting said printing apparatus from drawing more than 13-17 amps from an alternating current power socket.

16. A method to control a printing apparatus comprising:
using a controller that is operatively connected to all power consuming components within said printing apparatus to control a power supply that is also operatively connected to all said components; and
using said controller, selectively limiting operations of ones of said components to space the timing of different activities of said components to prevent all said components from collectively drawing from said power supply an amount of power that exceeds a predetermined amperage limit.

17. The method to control said printing apparatus according to claim 16, said limiting comprising prioritizing power allocation among said components.

18. The method to control said printing apparatus according to claim 16, said limiting comprising assigning different ones of said components different power priorities at different times during different operational cycles of said printing apparatus.

19. The method to control said printing apparatus according to claim 16, said limiting comprising delaying operations of relatively lower priority components and allowing operations of relatively higher priority components when a collective draw from both said lower priority components and said higher priority components would exceed said amperage limit.

20. The method to control said printing apparatus according to claim 16, said controller limiting said printing apparatus from drawing more than 13-17 amps from an alternating current power socket.
